(19) United States
(12) Patent Application Publication
(10) Pub. No.: US 2023/0314290 A1
(43) Pub. Date: Oct. 5, 2023

(54) System and Method for Extracting an Air Sample from a Sealed Package

(71) Applicant: Veros Global Solutions, LLC, (US)

(72) Inventors: John O'Rourke, Tampa, FL (US); Keith William Norman, Hocking (AU)

(21) Appl. No.: 17/707,598

(22) Filed: Mar. 29, 2022

(51) Int. Cl. G01N 1/22; G01N 1/44

(52) U.S. Cl. CPC G01N 1/2226; G01N 1/44; G01N 2001/2291

(57) ABSTRACT

Disclosed is a system and method for extracting an air sample from a sealed package for subsequent analysis for a range of compounds of interest or concern within the package. The system includes a sampling head with an actuator and a needle. The needle has retracted and extended positions relative to the actuator. A vacuum ring and switch are included at the end of the actuator. The switch determines when the sampling head is in physical contact with a top surface of the sealed package. After contact has been made, the vacuum ring draws a vacuum to secure the sampling head in place upon the package. The needle can then be extended to puncture the package and withdraw a sample of air for testing. Testing can subsequently be undertaken via a range of chemical detection methodologies.

### TECHNICAL FIELD

This disclosure relates to a system and method for extracting an air sample from a sealed container. More particularly, the disclosure relates extracting an air sample from a sealed package using a distance sensor, an extendable needle, a vacuum ring, and an air extraction process.

### BACKGROUND OF THE INVENTION

A current application for this device would be to aid in the interdiction of fentanyl, and its derivatives, at points of international export and importation. A 2021 report from the National Center for Drug Abuse Statistics (NCDAS) noted that 31.9 million adults (aged 12 and older) in the United States were dealing with substance abuse issues. This equates to nearly 11.7% of the total United States population in 2021. In the last several years the United States has been experiencing a change in drug abuse issues with the emergence of synthetic opioids. In 2020, The National Institute of Drug Abuse reported an estimate of 100,000 fatalities due to drug overdose. Of these fatalities near 70,000 were due to synthetic opioids.

The vast majority of the synthetic opioids, including fentanyl and its derivatives, are being produced outside the United States, often originating from countries such as China and Mexico. These consignments are moved by various means: vehicles, human courier, commercial cargo and aircraft. There is also increasing evidence that illicit substances are imported directly into the United States through the United States Postal Service and Express Consignment Carriers (ECC) such as: FedEx™, UPS™ and DHL™.

In an effort to identify, inspect and interdict these illicit international shipments the United States government is implementing new detection and screening technologies. In January 2018, Congress passed H.R. 2142 and President Trump signed the legislation creating Public Law 115-112; the International Narcotics Trafficking Emergency Response by Detecting Incoming Contraband with Technology (INTERDICT) Act. The purpose of this new legislation is to bring new and innovative technologies into the fight against narcotics trafficking. Section 3 of the INTERDICT Act requires Customs and Border Protection (CBP) to initiate two actions. The first is to increase the number of chemical screening devices available to interdict fentanyl, synthetic opioids and other psychoactive substances that are illegally imported into the United States via mail couriers and express consignment carriers. Secondly, the Act authorizes CBP to have the appropriate number of personnel, including scientists to interpret data collected by such devices during all “operational hours.”

CBP has made significant investments and improvements in drug detection, identification, and targeting capabilities. CBP officers use non-intrusive inspection, spectroscopic and chemical testing equipment, and narcotic detection canines to detect and presumptively identify illicit drugs, precursors and other prohibited materials at international mail and express consignment carrier facilities, airports and cargo handling facilities.

As of November 2017, most CBP canines working in the international mail and Express Consignment Carrier environments have been trained to detect fentanyl. Canine teams are one of the most reliable means of detecting the presence of illicit drugs, precursors and other prohibited materials. While the use of a reliable canine is a valuable tool to CBP and law enforcement at large, there are significant limitations, such as the number of trained dogs, fatigue of both the canine and the handler, 24/7/365 availability and long-term costs and sustainability. Additional to these is the potential toxicity of the new and emerging illicit drugs and chemical threats crossing the US border.

U.S. Pat. No. 5,347,845 teaches a system for sampling air inside a shipping container. The system uses a gas analyzer interconnected with a probe by a flexible conduit. This invention requires there to be an opening sealed by a film patch on the side wall of the shipping container. Here, a conveyor line arrangement positions the shipping container so that the film patch is facing the probe and only when the container is suitably positioned will an electro-solenoid interconnected with the probe be activated. The probe will then puncture the film patch and collect an air sample from within the shipping container.

U.S. Pat. No. 5,859,362 teaches a method and device for the detection of vapors of cocaine and associated compounds. The device is made up of a sampling, filtration, and vacuum port component that can be attached to a container and suction source. A sample of air is obtained and is passed through a filter that can retain the vapors of cocaine and associated compounds.

U.S. Pat. No. 7,032,467 teaches a method and apparatus for the collection of a concentrated sample from shipping packages without unsealing the package. Here, airflow is forced across existing hidden gaps or if necessary, creating a small incision. Air is injected into the gaps by either a probe or socket device in order to disturb and agitate the contents inside the package which then causes the contents to blend particulates into the air stream. The airborne particles are then channeled into a detection device.

The disclosed sample collection device provides a massive increase in capability above that of canines, as canines require breaks, down time and are susceptible to olfactory overload. In addition to the increased productivity, this system could be used to identify compounds that may pose health issues for both the canines and their handlers, along with identifying compounds that canines are not trained to identify. Furthermore, the disclosed sample collection system can be incorporated into the current package handling process with minimal interruptions or adapted at a vehicle crossing point with minimal interruption to the normal work flow. A fully automated system has the potential to operate unattended 24 hours per day, 7 days a week, all year long.

### SUMMARY OF THE INVENTION

One advantage of the present disclosure is that it permits a sampling head to be sealed to the surface of a package prior to an air sample being extracted.

Another advantage of the present disclosure is that it permits a sampling head to be positioned at a specific location above the package prior to the sampling head making contact with the package.

Another advantage of the present disclosure is that it can be fully automated and run uninterrupted.

These and other advantages are realized by a sampling head for extracting an air sample from a package. The sampling head comprising a switch for determining when the sampling head is in physical contact with the surface of the package, an actuator with a needle at a distal end, the needle having extended and retracted positions, a vacuum ring positioned about a lower end of the actuator, the vacuum ring adapted to create a vacuum seal that secures the sampling head to the top surface of the package, a microprocessor for controlling the operation of the sampling head, the microprocessor actuating the vacuum ring after the switch has determined that the sampling head is in contact with the package surface, the microprocessor thereafter positioning the needle into its extended position thereby inserting the needle through the top surface of the package, and a heated air line connected to the needle and adapted to extract an air sample from the package following the insertion of the needle.

It is therefore an object of the present disclosure to provide a sample collection system with a sampling head that can be positioned juxtaposed to a package, container or object for the purpose of collecting an air sample from the interior of the package, container, object or confined space.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a perspective view of the system of the present disclosure.

FIG. 2 is a perspective view of the sampling head.

FIG. 3 is a detailed view of the sampling head.

FIG. 4 is perspective, partial sectional, view of the frame.

FIG. 5 is a perspective view of the linear actuator.

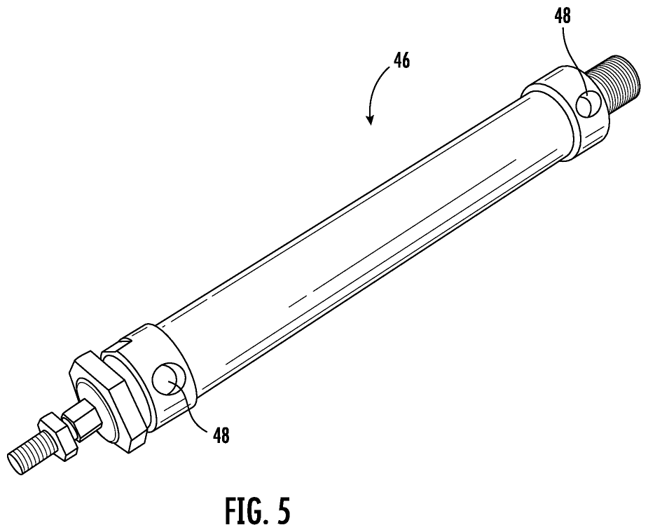

FIG. 6 is a perspective view of the distance sensor.

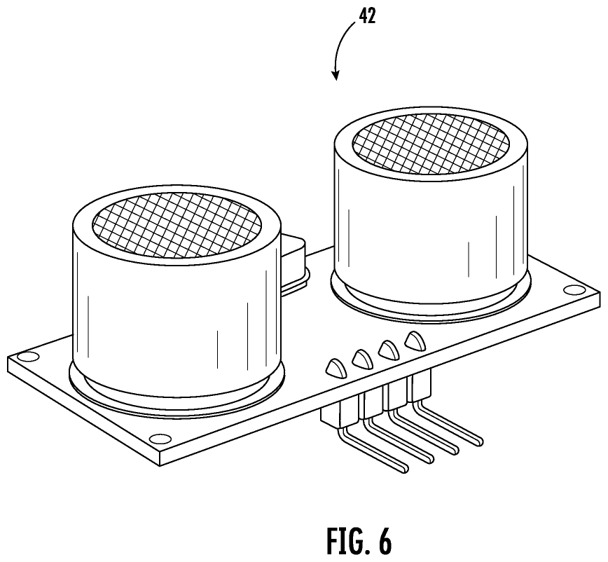

FIG. 7 is a perspective view of the microcontroller.

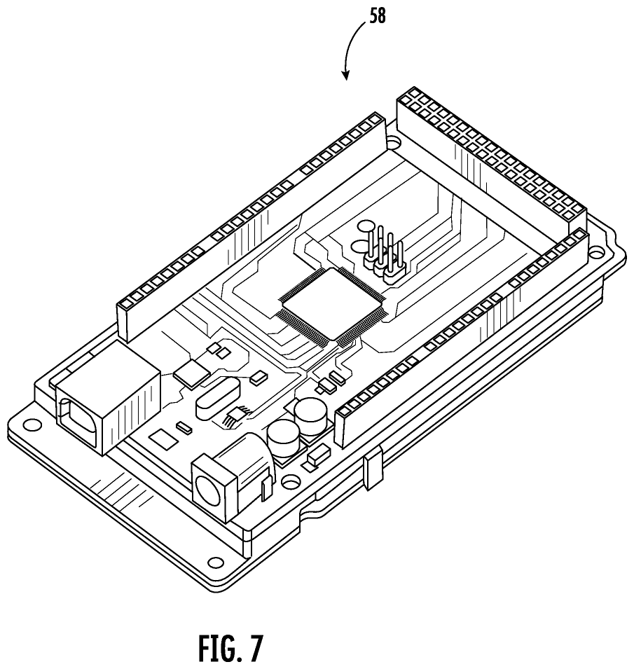

FIG. 8 is a flow chart illustrating the steps associated with the method of the present invention.

Similar reference numerals refer to similar parts throughout the several views of the drawings.

### DETAILED DESCRIPTION OF THE DRAWINGS

The present disclosure relates to a system and method for extracting an air sample from a sealed package and thereafter testing the sample for the presence of drugs or other types of illicit contraband. The system includes a sampling head with an actuator and a needle. The needle has retracted and extended positions relative to the actuator. A vacuum ring and switch are included at the end of the actuator. The switch determines when the sampling head is in physical contact with the sealed package. After contact has been made, the vacuum ring draws a vacuum to secure the sampling head in place. The needle can then be extended to puncture the package and insert purified air to increase the overall volume of air inside the package, to remove any obstructions from the needle, and to mix the purified air with the air already inside the package and then withdraw a sample of air for testing. The various components of the present invention, and the manner in which they interrelate, are described in greater detail hereinafter.

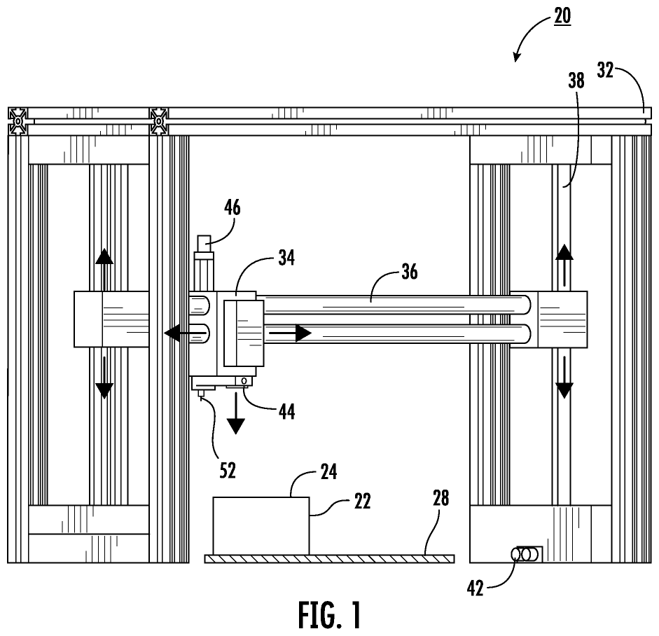

With reference to FIG. 1, the system (20) of the present disclosure is illustrated. System (20) allows for the extracting and testing of an air sample from within an individual sealed package (22). As illustrated, the individual sealed package (22) includes a top surface (24) through which the sample is withdrawn. The subsequent testing is achieved using a suitable chemical detector to identify the presence of compounds of interest and concern within the sealed package (22). The system (20) can be adapted to detect the presence of a wide variety of different substances, such as fentanyl, opioids, cocaine, methamphetamines, explosives, chemical warfare agents and the precursor materials for these compounds. The types of drugs detectable by the system are only limited by the “library of substances” to which the testing equipment is configured to chemically analyze and detect.

With continuing reference to FIG. 1, a conveyor (28) is illustrated for transporting multiple sealed packages. Conveyor (28) can be installed, for example, within a mail sorting facility, port of entry, or airport. Regardless of the location, conveyor (28) is used in routing, sorting, and inspecting a large number of packages. Although system (20) is ideally suited for use with conveyor, the present disclosure is not limited to such use. System (20) further includes a frame (32) positioned along the length of conveyor (28). Frame (32) facilities the positioning of sampling head (34) with respect to conveyor (28) and associated packages (22).

System (20) also includes means for detecting the presence of drugs or other contraband within an individual sealed package. As noted, a variety of different detection methodologies can be associated with the system (20). However, in the depicted embodiment, a mass spectrometer (26) is employed. Mass spectrometer (26) is ideally located at a position that is remote from the conveyor (28).

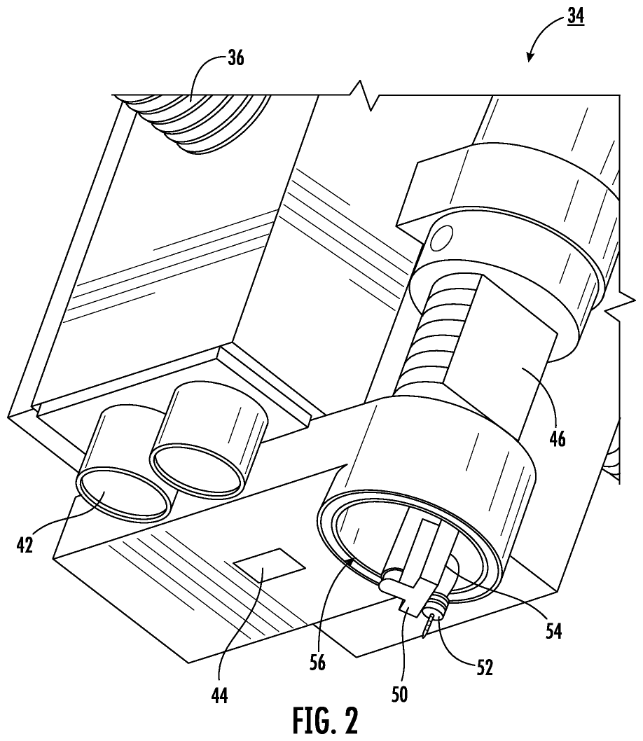

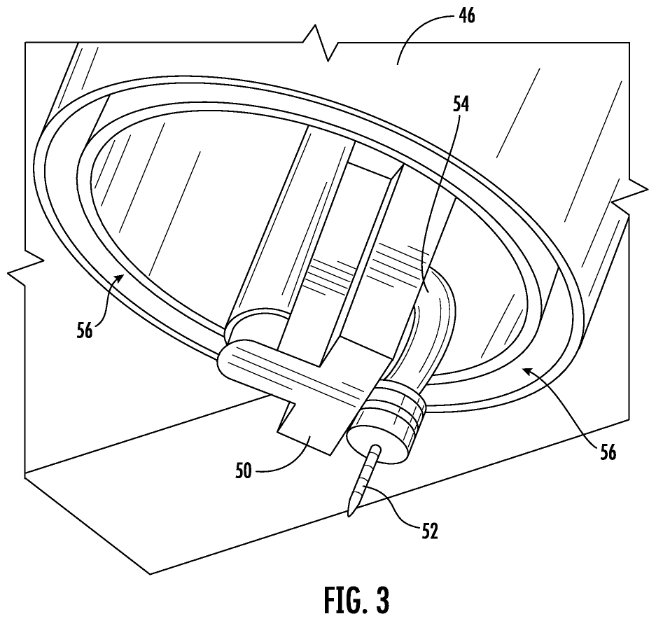

The sampling head (34) of the present disclosure is next described in connection with FIGS. 2 and 3. As illustrated, sampling head (34) is movably interconnected to the frame (32) via horizontally and vertically arranged worm gears (36, 38). Namely, the sampling head (34) can be horizontally positioned via gearing (36) and can be vertically positioned via gearing (38). Thus, the two worm gears (36, 38) allow for the selective positioning of the sampling head (34) anywhere within an interior area of the frame (32). This, in turn, allows the sampling head (34) to be brought into contact with a package (22) moving along conveyor (28). Sampling head (34) further includes an ultrasonic distance sensor (42) that is used to determine the distance between the sampling head (34) and a top surface (24) of the individual sealed package (22). Additional distance sensors (42) can be mounted upon frame (34) to provide additional accuracy.

Physical contact between sampling head (34) and the top surface (24) of package (22) is determined via a switch (44). Switch (44) is positioned on a lower surface of the sampling head (34) and is engaged when sampling head (34) is in direct, physical contact with package surface (24). Sampling head (34) further includes a linear actuator (46). In the preferred embodiment, the actuator (46) is pneumatically actuated with associated input and output ports (48). With reference to FIGS. 2 and 3, the retractable distal end (50) of the actuator is disclosed. This distal end (50) can be selected extended from or retraced into an opened, lower end of the actuator (46).

With continuing reference to FIGS. 2-3, the hollow needle (52) of the sampling head (34) is illustrated. In addition to being hollow, the needle (52) includes a side port (54) that allows for the extraction of air samples. Needle (52) is interconnected to the distal end (50) of the linear actuator (46) and accordingly has extended and retracted positions. Needle (52) assumes the extended position when it is being inserted into a package and is retracted at other times.

A vacuum ring (56) is positioned about the lower end of the linear actuator (46). Vacuum ring (56) is adapted to create a vacuum seal that secures the sampling head (34) to the top surface (24) of the individual sealed package (22). The vacuum seal also functions to make the top surface of the package taught to thereby facilitate the insertion of needle (52). This is especially useful for packages (22) that may have flexible or resilient top surfaces, such as a plastic shipping bag.

The operation of system (20) is governed by a microprocessor or microcontroller (58). For example, microcontroller (58) controls the operation of the distance sensor (42), switch (44), linear actuator (46), and vacuum ring (56). The microcontroller (58) is programmed to actuate the vacuum ring (56) to secure the individual sealed package (22) only after the switch (44) has determined that the sampling head (34) is in contact with the top surface (24). Microcontroller (58) is also programmed to position the needle (52) into its extended position to thereby insert the needle (52) through the top surface (24) of the individual sealed package (22) only after the sampling head (34) is secured.

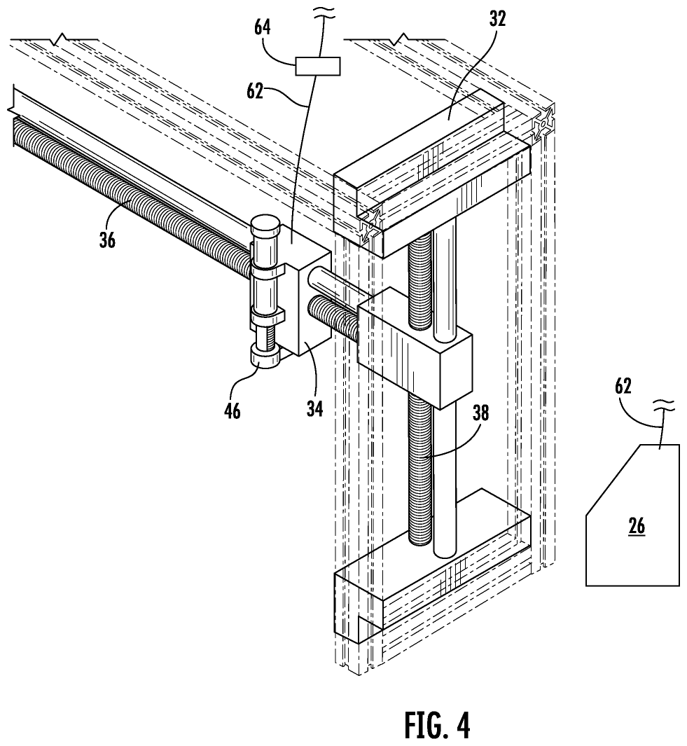

With reference to FIG. 4, a heated air line (62) interconnects the side port (54) of the needle to the detection and analysis system. Although air is preferred, other “working fluids” will suffice. A heating element (64) is associated with the air line (62) and is used in heating the air sample. The applied heat is sufficient to volatilize any organic compounds and permits subsequent analysis and detection. Following the insertion of the needle (52) into the package (22), the microcontroller (58) can be programmed to initially deliver a small burst of air into the individual package (22) following the insertion of the needle (52). This small burst of air creates a greater volume of air within the package, mixes the air already contained within the package and ensures that no obstructions are present prior to the air sample being obtained. Air line (62) thereafter extracts the air sample from the interior of the individual sealed package (22) and delivers it to the detection and analysis system. Upon completion of the extraction process to remove air from inside the individual package, the sampling head and associated airlines will be cleaned to avoid contamination of subsequent samples.

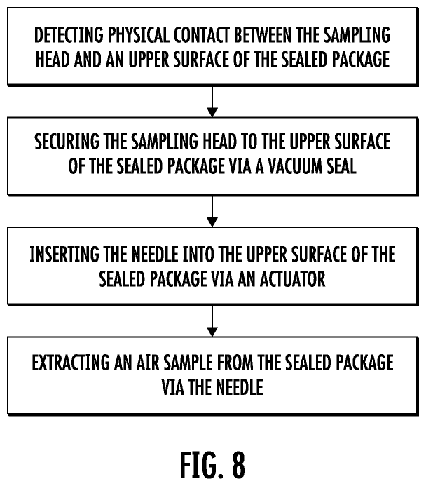

FIG. 8 is flow chart illustrating the steps of the associated method. These steps include first detecting when physical contact has been made between the sampling head and the top surface of the package. Thereafter, the sampling head is secured via the creation of a vacuum seal. Once the head has been secured, the needle is inserted into the package. Lastly, an air sample is extracted from the package and delivered to the detection and analysis system.

What is claimed is:

1. A system (20) for extracting and testing an air sample from an individual sealed package (22), the individual sealed package (22) having a top surface (24), the testing using a suitable chemical detector to detect the presence of a range of compounds of interest or concern within the sealed package (22), the system (20) comprising:
a conveyor (28) for transporting multiple sealed packages between first and second positions;
a frame (32) positioned at a location over the conveyor (28) and between the first and second positions;
a suitable chemical detector at a location that is remote from the conveyor (28), the suitable chemical detector functioning to detect the presence of a range of compounds of interest or concern within the air sample that is extracted from the sealed package (22);
a sampling head (34) movably interconnected to the frame (32) via horizontally and vertically arranged worm gears (36, 38), the worm gears (36, 38) selectively positioning the sampling head (34) within an interior area of the frame (32), the sampling head (34) further comprising:
a distance sensor (42) for determining the distance between the sampling head (34) and a top surface (24) of the individual sealed package (22);
a switch position (44) on a lower surface of the sampling head (34) for determining when the sampling head (34) is in physical contact with the top surface (24) of the sealed package (22);
a linear actuator (46) with a distal end (50), the distal end (50) of the linear actuator (46) having extended and retracted positions;
a needle (52) with a hollow interior and a side port (54), the needle (52) interconnected to the distal end (50) of the linear actuator (46) and having corresponding extended and retracted positions;
a vacuum ring (56) positioned about a lower end of the linear actuator (46), the vacuum ring (56) adapted to create a vacuum seal that secures the sampling head (34) to the top surface (24) of the individual sealed package (22), the vacuum seal also functioning to make the top surface of the package taught to thereby facilitate the insertion of needle (52);
a microcontroller (58) for controlling the operation of the distance sensor (42), switch (44), linear actuator (46), and vacuum ring (56), the microcontroller (58) actuating the vacuum ring (56) to secure the individual sealed package (22) after the switch (44) has determined that the sampling head (34) is in contact with the top surface (24), the microcontroller (58) thereafter positioning the needle (52) into its extended position thereby inserting the needle (52) through the top surface (24) of the individual sealed package (22);
an air line (62) interconnecting the side port (54) of the needle (52) to the suitable chemical detector and a heating element (64) associated with the air line (62), the air line (62) initially delivering a small burst of air into the individual package (22) following the insertion of the needle (52), the air line (62) thereafter extracting an air sample from the interior of the individual sealed package (22), the heating element (64) raising the temperature of the air sample to volatilize all organic materials for subsequent analysis via the suitable chemical detector.

2. A sampling head for extracting an air sample from a package, the package having a top surface, the sampling head comprising:
a switch for determining when the sampling head is in physical contact with the top surface of the package;
an actuator with a needle at a distal end, the needle having extended and retracted positions;
a vacuum ring positioned about a lower end of the actuator, the vacuum ring adapted to create a vacuum seal that secures the sampling head to the top surface of the package;
a microprocessor for controlling the operation of the sampling head, the microprocessor actuating the vacuum ring after the switch has determined that the sampling head is in contact with the top surface, the microprocessor thereafter positioning the needle into its extended position thereby inserting the needle through the top surface of the package;
an air line connected to the needle and adapted to extract an air sample from the package following the insertion of the needle.

3. The sampling head as described in claim 2 wherein the air line is connected to a suitable chemical detector to detect the presence of a range of compounds of interest or concern within the extracted air sample.

4. The sampling head as described in claim 2 wherein the vacuum seal created by the vacuum ring creates rigidity in the top surface of the package, the rigidity facilitating the insertion of the needle.

5. The sampling head as described in claim 2 wherein the needle inserts a small burst of air into the package prior to extracting an air sample.

6. The sampling head as described in claim 2 further comprising an ultrasonic distance sensor for determining the distance between the sampling head and the top surface of the package.

7. The sampling head as described in claim 3 further comprising a heating element associated with the air line, the heating element raising the temperature of the air sample to volatilize all organic materials and thereby facilitate subsequent analysis via the suitable chemical detector.

8. The sampling head as described in claim 2 wherein the sampling head further comprises a video camera for recording the extraction process.

9. The sampling head as described in claim 2 wherein the needle extracts a sample having a volume of approximately 100 milliliters.

10. A method for withdrawing an air sample from a sealed package, the sealed package having an upper surface, the method employing a sampling head, the sampling head including a linear actuator with a needle at a distal end, the needle having retracted and extended positions, a vacuum ring and a switch positioned at a lower end of the linear actuator, and an air line connected to the needle, the method comprising the following steps:
detecting via the switch when the sampling head has come into physical contact with the upper surface of the sealed package;
securing the sampling head to the top surface of the sealed package, the sampling head being secured via a vacuum applied by the vacuum ring, the vacuum only being applied after the switch has detected physical contact with the upper surface of the sealed package;
extending the needle via the linear actuator so that the needle punctures the upper surface of the sealed package, the needle only being extended after the sampling head has been secured to the top surface of the sealed package;
extracting the air sample from the sealed package via the needle and air line.
